(19) United States
(12) Patent Application Publication
(10) Pub. No.: US 2023/0084807 A1
(43) Pub. Date: Mar. 16, 2023

(54) SYSTEMS AND METHODS FOR 3-D RECONSTRUCTION AND SCENE SEGMENTATION USING EVENT CAMERAS

(71) Applicant: INTRINSIC INNOVATION LLC, Mountain, CA (US)

(72) Inventors: Vage TAAMAZYAN, Balashikha (RU); Agastya KALRA, Nepean (CA); Achuta KADAMBI, Los Altos Hills, CA (US); Kartik VENKATARAMAN, San Jose, CA (US)

(21) Appl. No.: 17/477,427

(22) Filed: Sep. 16, 2021

(51) Int. Cl. G01B 11/25; G06T 7/11; G06T 7/80; G06K 9/62

(52) U.S. Cl. CPC G01B 11/2513; G06T 7/11; G06T 7/80; G01B 11/2518; G06K 9/628

(57) ABSTRACT

Aspects of embodiments of the present disclosure relate to systems and methods for performing three-dimensional reconstruction (or depth reconstruction) and for generating segmentation masks using data captured by one or more event cameras.

### FIELD

Aspects of embodiments of the present disclosure relate to techniques in computer vision, including performing 3-D reconstruction and scene segmentation using event cameras.

### BACKGROUND

Three-dimensional (3-D) reconstruction of scenes is class of computer vision problems relating to estimating the three-dimensional shapes of surfaces in a scene, typically through the use of one or more cameras that capture two-dimensional images of the scene. Such three-dimensional reconstruction techniques have applications in robotics, such as in computing the 3-D shape of the surroundings of a robot for performing navigation around obstacles and for avoiding collisions as well as in computing the 3-D shape of objects and the context of those objects for picking and placing those objects. Other applications include manufacturing, including generating 3-D models for the automated inspection of manufactured workpieces (e.g., inspecting welds on metal parts or solder joints on printed circuit boards).

In the field of computer vision, segmentation refers to partitioning a digital image into multiple segments (e.g., sets of pixels). For example, image segmentation refers to assigning labels to pixels that have certain characteristics, such as classifying the type of object depicted by a set of pixels (e.g., in a family portrait, labeling pixels as depicting humans or dogs or foliage), and instance segmentation refers to assigning unique labels to sets of pixels corresponding to each separate instance of a type (e.g., assigning different labels to each of the humans in the image and different labels to each of the dogs in the image).

The above information disclosed in this Background section is only for enhancement of understanding of the present disclosure, and therefore it may contain information that does not form the prior art that is already known to a person of ordinary skill in the art.

### SUMMARY

Aspects of embodiments of the present disclosure relate to computer vision systems using event cameras. Event cameras, sometimes referred to as motion contrast cameras or dynamic vision sensors (DVS), generate events on a pixel level when a given pixel detects a change in illumination. In some embodiments, structured light projectors are used to illuminate a scene and event cameras are used to detect the changes in illumination due to the projected patterns in order to detect the three-dimensional shapes of surfaces in the scene.

According to one embodiment of the present disclosure, an active scanning system includes: an event camera including a plurality of event pixels configured to generate change events based on detecting changes in detected brightness; a projection system; a controller configured to receive camera-level change events from the event camera, the controller including a processor and memory, the memory storing instructions that, when executed by the processor, cause the controller to: receive first change events from the event camera corresponding to a first pattern projected by the projection system into a scene in a field of view of the event camera; and compute a plurality of depths of surfaces imaged by the event camera at the event pixels associated with the first change events to generate a depth map.

The memory may further store instructions that, when executed by the processor, cause the controller to: receive additional change events from the event camera corresponding to additional patterns projected by the projection system into the field of view of the event camera; reconstruct a plurality of illumination codes based on the first change events and the additional change events detected by the event camera, each of the plurality of illumination codes being associated with a corresponding one of the event pixels of the event camera; and compute the plurality of depths of surfaces imaged by the event camera at the event pixels associated with the plurality of illumination codes based on the illumination codes and a plurality of calibration parameters between the projection system and the event camera.

The additional patterns may include two or more patterns.

The memory may store instructions that, when executed by the processor, cause the controller to control the projection system to project the first pattern during a first time period.

The memory may further store instructions that, when executed by the processor, cause the controller to control the projection system to project the additional patterns during a plurality of additional time periods.

The active scanning system may further include a second event camera forming a stereo pair with the event camera, and the memory may further store instructions that, when executed by the processor, cause the controller to: receive second change events from the second event camera corresponding to the first pattern projected by the projection system into the field of view of the second event camera.

The memory may further store instructions that, when executed by the processor, cause the controller to compute the plurality of depths of surfaces imaged by the event camera to generate the depth map by: computing a disparity map by matching blocks of events among the first change events and the second change events corresponding to same portions of the first pattern projected by the projection system.

The memory may further stores instructions that, when executed by the processor, cause the controller to: receive third change events from the event camera during a period in which the field of view of the event camera is under substantially constant illumination; compute one or more silhouettes of one or more moving objects based on the third change events; compute a segmentation mask based on the one or more silhouettes; and segment the depth map based on the segmentation mask to compute a segmented depth map.

According to one embodiment of the present disclosure, a scanning system includes: an event camera including a plurality of event pixels configured to generate change events based on detecting changes in detected brightness; a controller configured to receive camera-level change events from the event camera, the controller including a processor and memory, the memory storing instructions that, when executed by the processor, cause the controller to: receive first change events from the event camera during a period in which a scene in a field of view of the event camera is under substantially constant illumination; compute one or more silhouettes of one or more moving objects based on the first change events; and compute a segmentation mask corresponding to the one or more moving objects based on the one or more silhouettes.

The memory may further store instructions that, when executed by the processor, cause the processor to perform instance segmentation on the segmentation mask to compute an instance segmentation mask labeling images of the one or more moving objects based on one or more object classifications.

According to one embodiment of the present disclosure, a method for performing three-dimensional reconstruction of scenes includes: projecting, by a projection system, a first pattern onto a scene; receiving, by a controller including a processor and memory, first change events from an event camera, the first change events corresponding to the first pattern projected by the projection system into a scene in a field of view of the event camera, the event camera including a plurality of event pixels configured to generate change events based on detecting changes in detected brightness; and computing, by the controller, a plurality of depths of surfaces imaged by the event camera at the event pixels associated with the first change events to generate a depth map.

The method may further include: projecting, by the projection system, additional patterns onto the scene in the field of view of the event camera; receiving, by the controller, additional change events from the event camera corresponding to the additional patterns projected by the projection system; reconstructing, by the controller, a plurality of illumination codes based on the first change events and the additional change events detected by the event camera, each of the plurality of illumination codes being associated with a corresponding one of the event pixels of the event camera; and computing, by the controller, the plurality of depths of surfaces imaged by the event camera at the event pixels associated with the plurality of illumination codes based on the illumination codes and a plurality of calibration parameters between the projection system and the event camera.

The additional patterns may include two or more patterns.

The method may further include controlling the projection system to project the first pattern during a first time period.

The method may further include controlling the projection system to project the additional patterns during a plurality of additional time periods.

The method may further include receiving second change events from a second event camera forming a stereo pair with the event camera, the second change events corresponding to the first pattern projected by the projection system into the field of view of the second event camera.

The method may further include computing the plurality of depths of surfaces imaged by the event camera to generate the depth map by: computing a disparity map by matching blocks of events among the first change events and the second change events corresponding to same portions of the first pattern projected by the projection system.

The method may further include: receiving third change events from the event camera during a period in which the field of view of the event camera is under substantially constant illumination; computing one or more silhouettes of one or more moving objects based on the third change events; computing a segmentation mask based on the one or more silhouettes; and segmenting the depth map based on the segmentation mask to compute a segmented depth map.

According to one embodiment of the present disclosure, a method for segmenting an image of a scene includes: receiving, by a controller including a processor and memory, first change events from an event camera during a period in which a scene in a field of view of the event camera is under substantially constant illumination, the event camera including a plurality of event pixels configured to generate change events based on detecting changes in detected brightness; computing, by the controller, one or more silhouettes of one or more moving objects based on the first change events; and computing, by the controller, a segmentation mask corresponding to the one or more moving objects based on the one or more silhouettes.

The method may further include performing instance segmentation on the segmentation mask to compute an instance segmentation mask labeling images of the one or more moving objects based on one or more object classifications.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a block diagram of an active scanning system with a structured light projector and an event camera according to one embodiment of the present disclosure.

FIG. 2 is a schematic diagram of an event camera used with system according to some embodiments of the present disclosure.

FIG. 3A is a schematic depiction of a series of patterns projected by a structured light projection system according to some embodiments of the present disclosure.

FIG. 3B is a schematic depiction of light incident on three pixels over the course of several patterns projected on a scene.

FIG. 3C is a schematic depiction of light incident on a three subject pixels of the camera over the course a time period in which several patterns ordered in a Gray code are projected on a scene imaged by the camera.

FIG. 4 is a flowchart of a method for computing the depth of pixels based on events detected by an event camera in a system according to some embodiments of the present disclosure.

FIG. 5A is a schematic depiction of the scene brightness detected at a portion of an image sensor of an event camera due to a first projected pattern during a first time period according to one embodiment of the present disclosure.

FIG. 5B is a schematic depiction of the scene brightness detected at the portion of the image sensor of the event camera due to a second projected pattern during a second time period according to one embodiment of the present disclosure.

FIG. 5C is a schematic depiction of the change events output by an event camera due to the change in the brightness detected due to the first projected pattern during the first time period and the second projected pattern during the second time period.

FIG. 6A is a schematic depiction of a computer vision system including an event camera imaging a conveyor belt with a plurality of different objects, where the computer vision system is configured to segment the objects from the scene, such as by compute segmentation masks, based on events generated by the event camera, according to one embodiment of the present disclosure.

FIG. 6B is a schematic depiction of events generated by an event camera imaging objects moving along a conveyor belt according to one embodiment of the present disclosure.

FIG. 7 is a flowchart of a method for computing segmentation masks based on camera-level event data from an event camera according to one embodiment of the present disclosure.

FIG. 8 is a flowchart of a method for computing a segmented depth map according to one embodiment of the present disclosure.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein.

Three-dimensional (3-D) reconstruction of scenes and scene segmentation are two computer vision tasks that are commonly performed on captured two-dimensional images of a scene. Three-dimensional reconstruction generally refers to computing depth maps or 3-D models (in the form of point clouds, and/or mesh models) of scenes and objects imaged by an imaging system. Scene segmentation generally refers to partitioning a captured image into different sets of pixels corresponding to semantically different classes, such as separating foreground objects from background, classifications of objects, and/or identifying separate instances of objects of the same type or of different types. These computer vision tasks may be performed to generate higher-level semantic information about a scene, such as the three-dimensional shapes of surfaces in the scene and the segmentation of those surfaces into individual objects, thereby enabling the control of a robotic system to pick up particular objects and/or plan a path to navigate around obstacles in a scene or the use of a defect detection system to analyze specific instances of objects for defects that are specific to a particular category of object.

Some comparative computer vision systems use standard monochrome or color cameras to capture images of a scene, where such cameras typically capture images (or “frames”) at a specified frame rate (e.g., 30 frames per second), where each captured image encodes the absolute intensity of light (or brightness) detected at each pixel of the image sensor of the camera. The frame rate of such standard cameras may be limited by the lighting conditions of the scene, where darker scenes may require increased exposure, such as by increasing the exposure time (e.g., decreasing shutter speed) or increasing sensor gain (commonly referred to as “ISO”). However, increasing sensor gain generally increases the sensor noise in the captured image, and longer exposure times can reduce the frame rate of the system and/or cause the appearance of motion blur when objects in the scene are moving quickly relative to the exposure time. Fast moving objects and inconsistent or poor illumination are frequently found in active environments such as factories and logistics facilities, making it challenging for robotic systems that use standard cameras to capture information about their environments. For example, visual artifacts such as noise and motion blur can reduce the accuracy of any generated object segmentation maps and 3-D models (e.g., point clouds) generated from such 2-D images, and this reduced accuracy may make robotic motion planning and other visual analysis more difficult for the robotic systems. Increasing illumination may not always be an option due to, for example, the ambient lighting conditions (which may be variable over time) and power constraints on any active light projection systems that are part of the computer vision system.

Aspects of embodiments of the present disclosure relate to computer vision systems that capture images using event cameras. An event camera is a type of image capture device that captures the change of brightness at each pixel instead of capturing the actual brightness value at a pixel. Each pixel of event camera operates independently and asynchronously. In particular, the pixels of an event camera do not generate data (events) when imaging a scene that is static and unchanging. However, when a given pixel detects a change in the received light that exceeds a threshold value, the pixel generates an event, where the event is timestamped and may indicate the direction of the change in brightness at that pixel (e.g., brighter or darker) and, in some cases, may indicate the magnitude of that change. Examples of event camera designs, representation of event camera data, methods for processing events generated by event cameras, and the like are described, for example, in Gallego, G., Delbruck, T., Orchard, G. M., Bartolozzi, C., Taba, B., Censi, A., . . . & Scaramuzza, D. (2020). Event-based Vision: A Survey. IEEE Transactions on Pattern Analysis and Machine Intelligence, 1 and Posch, Christoph, et al. “Retinomorphic event-based vision sensors: bioinspired cameras with spiking output.” Proceedings of the IEEE 102.10 (2014): 1470-1484.

Using event cameras for computer vision tasks in accordance with embodiments of the present disclosure enables the high speed, low latency detection of changes in the scene (e.g., due to illumination or motion) and enables computer vision systems to operate in a higher dynamic range of ambient illumination levels because the pixels of the event camera measure and report on only changes in brightness rather, than the absolute brightness or intensity across all of the pixels.

3-D reconstruction using event cameras

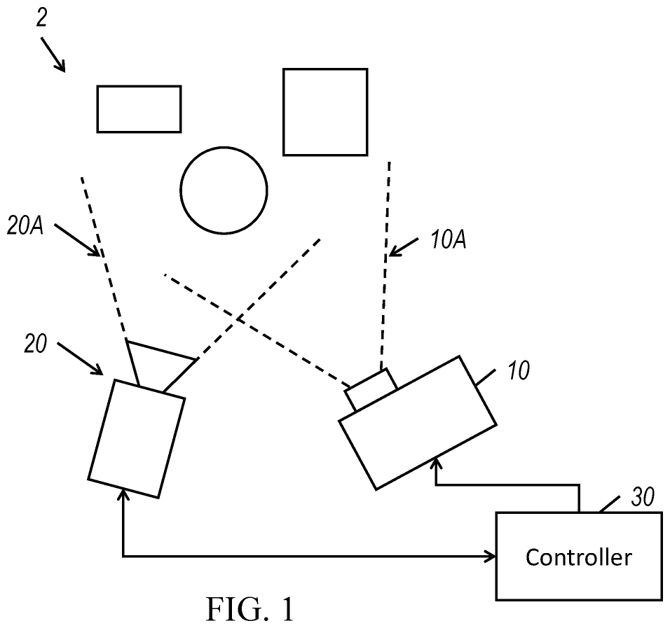

FIG. 1 is a block diagram of an active scanning system 1 with a projection system 10 and an event camera 20 according to one embodiment of the present disclosure. A controller 30 (or controller system) is configured to control the projection system 10 to project or emit structured light onto a scene 2 in a field of projection 10A and to receive image data (e.g., events) from the event camera 20, where the event camera 20 images the scene 2, such as by having a field of view 20A that encompasses the scene 2, where the scene 2 may include various objects.

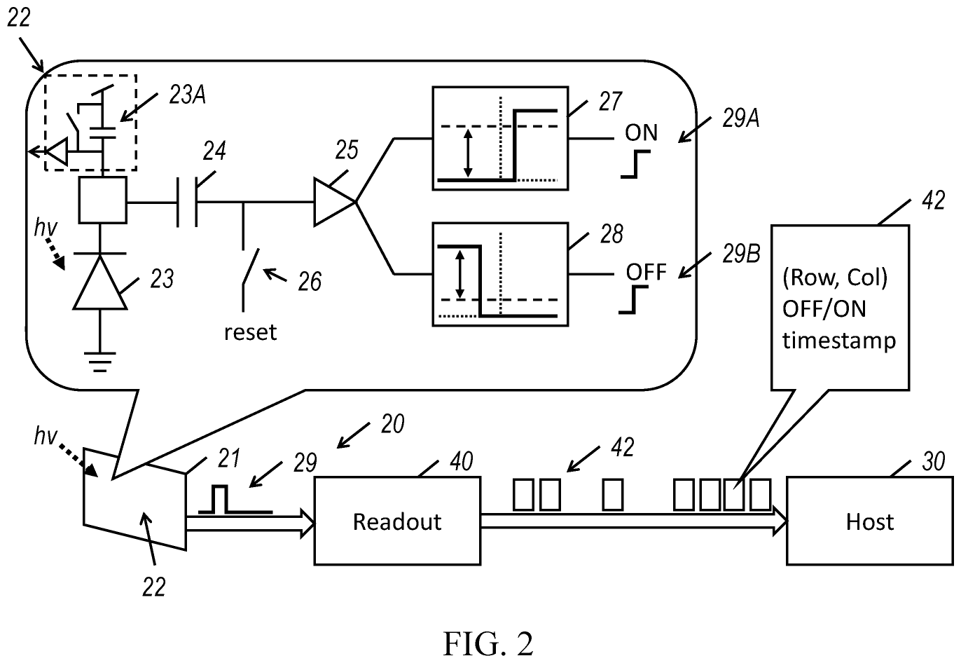

FIG. 2 is a schematic diagram of an event camera used with system according to some embodiments of the present disclosure. While FIG. 2 depicts one example possible implementation, embodiments of the present disclosure are not limited thereto and other designs and architectures for event cameras, motion contrast cameras, dynamic vision sensors (DVS), and the like may be used. In the embodiment shown in FIG. 2, an event camera includes an image sensor 21 with an array of pixels 22 thereon. Each pixel 22 of the image sensor 21 includes a photodetector 23 (e.g., a photodiode) and a filter 24 (e.g., a capacitor) at the input of an amplifier 25. A reset switch 26 may be used to reset the capacitor, e.g., to reset the baseline illumination level of the pixel 22. A first comparator 27 is configured to generate a pixel-level ON event 29A in response to detecting an increase in detected intensity that exceeds a threshold value (indicated by the dashed line and the double headed arrow). Likewise, a second comparator 28 is configured to generate a pixel-level OFF event 29B in response to detecting a decrease in detected intensity that exceeds a threshold value (indicated by the dashed line and the double headed arrow). Each pixel generates pixel-level events 29 independently and asynchronously transmits the events to a readout circuit 40 of the event camera 20. Each pixel 22 may also include a standard, frame-based active pixel sensor (APS) 23A such that the event camera can also operate to capture full frames of images in a manner similar to a standard digital camera.

The readout circuit 40 is configured to generate camera-level change events 42 based on the pixel-level events 29 received from the individual pixels 22. In some embodiments, each camera-level change event 42 corresponds to a pixel-level event 29 and includes the row and column of the pixel that generated the event (e.g., the (x, y) coordinates of the pixel 22 within the image sensor 21), whether the pixel-level event 29 was an ON event 29A or an OFF event 29B, and a timestamp of the pixel-level event 29. The readout rates vary depending on the chip and the type of hardware interface, where current example implementations range from 2 MHz to 1,200 MHz. In some embodiments of event cameras, the camera-level events are timestamped with microsecond resolution. In some embodiments, the readout circuit 40 is implemented using, for example, a digital circuit (e.g., a field programmable gate array, an application specific integrated circuit, or a microprocessor).

In some embodiments of event cameras, the intensity measurements are made on a log scale and pixels 22 generate pixel-level events 29 based on log intensity change signals as opposed to linear intensity change signals. Such event cameras may be considered to have built-in invariance to scene illumination and may further provide event cameras with the ability to operate across a wide dynamic range of illumination conditions.

A comparative “standard” digital camera uses an image sensor based on charge-coupled device (CCD) or complementary metal oxide semiconductor (CMOS) active pixel sensor technologies captures images of a scene, where each image is represented as a two dimensional (2-D) grid or array of pixel values. The entire image sensor is exposed to light over a time interval, typically referred to as an exposure interval, and each pixel value represents the total amount of light (or an absolute amount of light) received at the pixel over that exposure interval (e.g., integrating the received light over time), where pixels generate signals representing the amount or intensity or brightness of light received over substantially the same exposure intervals. Each image captured by a digital camera may be referred to as an image frame, and a standard digital camera may capture many image frames one after another in sequence at an image frame rate that is limited by, for example, the exposure intervals of the individual frames, the sensitivity of the image sensor, the speed of the read-out electronics, and the like. Examples of typical image frame rates of standard digital cameras are 30 to 60 frames per second (fps), although some specialized digital cameras are capable of briefly capturing bursts of images at higher frame rates such as 1,000 frames per second.

Some of the limitations on the frame rates of digital cameras relate to the high bandwidth requirements of transferring full frames of data and exposing the pixels to a sufficient amount of light (e.g., a sufficient number of photons) to be within the operating dynamic range of the camera. Longer exposure intervals may be used to increase the number of photons, but come at the cost of decreased frame rates and motion blur in the case of imaging moving objects. Increased illumination, such as in the form of a flash or continuous lighting may also improve exposure, but such arrangements increase power requirements and such arrangements may not be available in many circumstances. Bandwidth requirements for transferring image data from the image sensor to memory and storing images for later analysis may be addressed by capturing images at lower resolutions (e.g., using lower resolution sensors, using only a portion of the image sensor, or decimating data from the image sensor), and/or by using larger amounts of expensive, high speed memory.

In the field of computer vision, “structured light” refers to one category of approaches to reconstructing the three-dimensional shapes of objects using two-dimensional cameras. Structured light 3-D scanning is one of the most precise and accurate techniques for depth reconstruction or 3-D reconstruction. Generally, a structured light projector projects a sequence of patterns onto a scene within its field of projection 10A and a standard digital camera captures 2-D images of the scene within its field of view, where an image is captured for each pattern that is projected onto the scene. Here, it is also assumed that the scene is substantially static (e.g., unchanging) across the projection of the different patterns. The camera is spaced apart from the structured light projector along a baseline and has a field of view that images the portion of the scene that is illuminated within the field of projection of the structured light projector. The camera and the structured light projector are also calibrated with respect to one another (e.g., where the three-dimensional positions and rotations of the projector and camera and known with respect to one another).

In the simplest case, a laser scanner may emit light at a single point within its field of projection, such as at location (xₚ, yₚ) within a two-dimensional grid representing directions that are within its field of projection. Due to parallax shifts from the different locations of the laser scanner and the camera, the appearance of the position of the single illuminated point in the field of view of the camera, such as at location (x_{c}, y_{c}) within a two-dimensional grid representing its image sensor, will depend on the depth of the surface in the scene (or distance of the surface from the projector/camera system) that reflects the projected light. As such, using the known relative poses of the laser projector and the camera system, along with the known direction of the emitted ray of light through location (xₚ, yₚ) and the detected pixel coordinates of the reflected light within the field of view of the camera at (x_{c}, y_{c}), the depth of the surface of the scene at the imaged point can be triangulated. However, projecting light at a single point at a time and capturing one image frame for each such point may result in long scan times.

One approach to accelerating the 3-D scanning process is to emit a single stripe of light, where the stripe of light is perpendicular to the baseline between the structured light projector and the camera. Based on the known calibration of the camera with respect to the laser scanner and due to epipolar constraints, the projected light at a given point of the single stripe will be found along the projection of the epipolar line in the captured image. The single stripe can then be swept across the field of projection (e.g., swept along a direction parallel to the epipolar lines) to scan over the scene. However, such an approach may still be relatively slow.

Accordingly, some approaches relate to projecting patterns of light concurrently or substantially simultaneously across substantially an entire field of projection. This, however, may create ambiguities because, for some given detected light at the camera, it may be difficult to determine the direction in which the light was emitted within the field of projection (e.g., from among multiple possible directions of emission). To address the ambiguity, multiple different patterns may be projected over time by a structured light projector, where the patterns of light are designed such that it can be determined, from the captured images, which portions of the scene are illuminated by particular locations within the field of projection of the structured light projector.

In particular, in some approaches, each location within the field of projection (e.g., each “pixel” within the field of projection) may be associated with a corresponding code (or illumination code representing whether or not the location was illuminated by the projection system during a particular time period in which a particular pattern was emitted) and therefore the direction of emission of the projected light can be determined based on that detected code. For example, a sequence of different binary patterns of stripes may be projected onto the scene, where different positions within the field of projection are “on” or “off” in different patterns, and where the sequence of “on” and “off” patterns encodes the location of the emitted light within the field of projection. Accordingly, different portions of the scene 2 are illuminated by different patterns over time. For any given portion of the scene, periods during which that portion is not illuminated by the projection system 10 may be considered to be “off” or have code “0,” and periods where that portion of the scene is illuminated by the projection system 10 may be considered to be “on” or have code “1.” The sequence of “0” and “1” periods for a given portion of the scene can be referred to as a code, such that each portion of the scene has a different code in accordance with whether it is illuminated or not illuminated by the projection system 10 over the course of projecting multiple patterns on the scene over time.

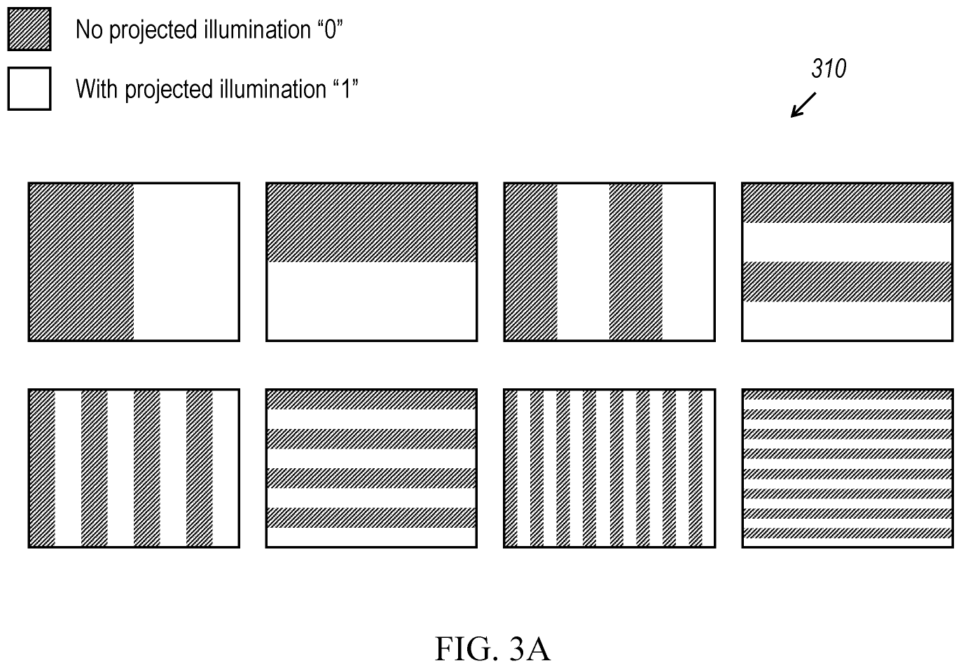

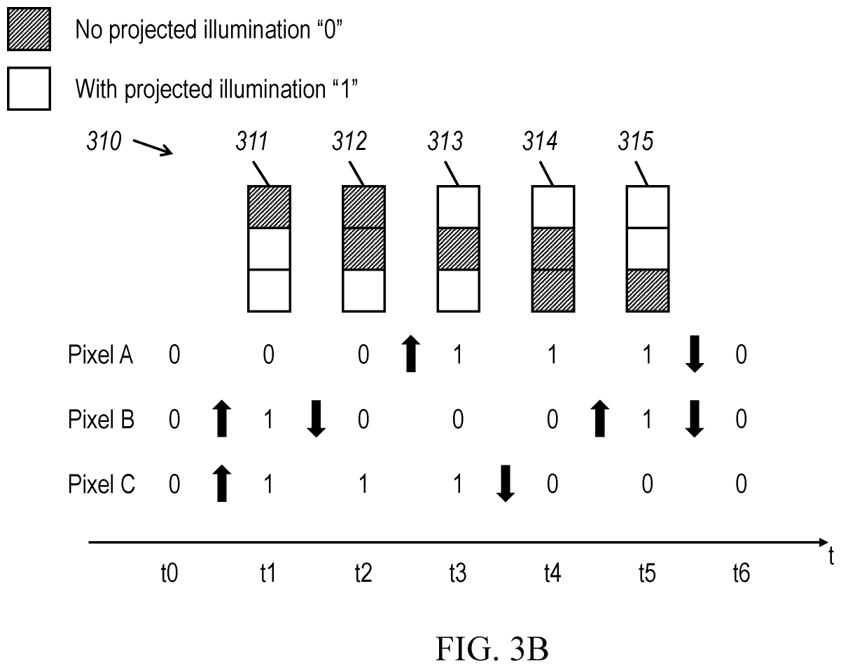

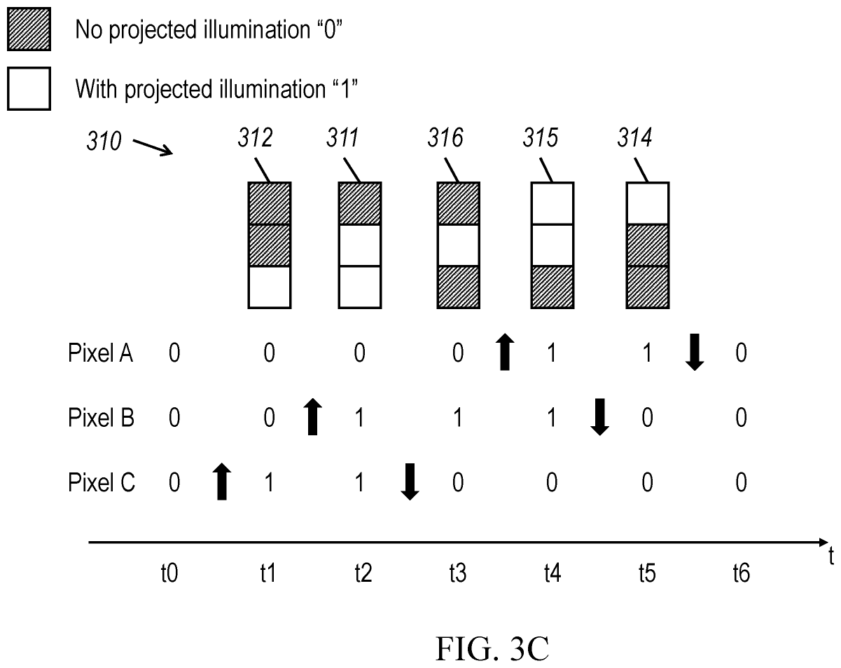

FIG. 3A is a schematic depiction of an example series of patterns projected by a structured light projection system that may be used in some embodiments of the present disclosure. In the example shown in FIG. 3A, the set of binary structured light patterns encode the locations of projected portions of the pattern within a field of projection of a structured light projector within a 16×16 grid.

Additional details regarding structured light 3-D surface imaging can be found, for example, in Zhang, Song. “High-speed 3D shape measurement with structured light methods: A review.” Optics and Lasers in Engineering 106 (2018): 119-131. In addition, examples of patterns for structured light can be found in, for example, Geng, Jason. “Structured-light 3D surface imaging: a tutorial.” Advances in Optics and Photonics 3.2 (2011): 128-160.

Structured light scanning techniques face tradeoffs between the precision and scanning frame rate (e.g., the number 3-D scans than can be completed per unit time, such as the total time required to project all of the patterns onto the scene and capture images for each of the patterns). The most accurate structured light scanning techniques require multiple images captured with a sequence of different patterns projected on the scene (e.g., binary coding). For example, the set of patterns 310 shown in FIG. 3A merely provide 16×16 resolution, which may be insufficient for detailed reconstruction of the shape of the objects of the scene. However, because different portions of the scene need to be uniquely coded, projecting additional, denser patterns requires substantially more time, thereby decreasing the scanning frame rate.

In the example set of binary patterns 310 shown in FIG. 3A, there are many cases where the structured light projector projects the same level of illumination to a portion of the field of projection over the course of multiple frames. In addition, under the assumption that the scene remains substantially static across the projection of the sequence of different patterns, a standard camera captures a large amount of redundant information in the form of pixels that have the same appearance when illuminated by different patterns, because the 3-D reconstruction process uses the change in intensity between different patterns rather than the actual intensity value at each pixel. However, in comparative structured light imaging systems using standard cameras, this redundant data is still captured, transmitted to a host system, and processed to reconstruct the 3-D shape of the surfaces of the scene. This redundant data imposes therefore imposes demands on bandwidth, such is in the form of data transfer from the image sensor to an image signal processor of the camera, data to be processed by the image signal processor, data to be transmitted to a host or controller, and data to be processed by the host for performing 3-D reconstruction.

FIG. 3B is a schematic depiction of light incident on a three subject pixels of the camera over the course a time period in which several patterns projected on a scene imaged by the camera. Different binary patterns 310 are projected during different time intervals t1, t2, t3, t4, and t5. Periods in which the binary pattern emits light onto the subject pixels A, B, and C of the camera are labeled “1” and periods in which the binary pattern does not emit light onto the subject pixels A, B, and C are labeled “0.” In the example shown in FIG. 3B, no light is projected onto the scene 2 in period t0, thereby establishing a baseline intensity of light received from the scene 2 due to reflections from ambient lighting. In addition, in the example shown in FIG. 3B, no pattern or projection is projected in time interval t6, which occurs after the binary patterns 310 have been projected for a particular 3-D scan or 3-D reconstruction operation.

The projection system 10 emits different binary patterns 311, 312, 313, 314, and 315 during periods t1, t2, t3, t4, and t5, respectively. For example, referring to Pixel C shown in FIG. 3B, the structured light projector emits light in a direction (e.g., through coordinates (xₚ, yₚ) of its field of projection) that reflects off the scene 2 to be detected by Pixel C during periods t1, and t2, and t3 and does not emit light in that direction (e.g., e.g., does not emit light through coordinates (xₚ, yₚ) of its field of projection) during periods t4 and t5. Accordingly, Pixel A detects light in accordance with the code 00111, Pixel B detects light in accordance with the code 10001, and Pixel C detects light in accordance with the code 11100.

Because the intensity of light falling on Pixel C is constant over periods t1, t2, and t3, it is redundant to repeatedly generate data regarding the measured intensity for time periods t2 and t3. For example, it would be sufficient to indicate the change from baseline brightness at period t0 to illuminated at period t1, as indicated by the upward arrow between time periods t0 and t1. Likewise, because the intensity of the light falling on the pixel over periods t4 and t5 is constant, it is redundant to repeatedly generate the same detected light intensity for period t5. Instead, it would be sufficient to indicate the change from illuminated to not-illuminated between periods t3 and t4, as indicated by the downward arrow between time periods t3 and t4. Arrows are shown in the rows corresponding to Pixels A and B accordingly. For example, for Pixel A there is an upward arrow between time periods t2 and t3 and a downward arrow between time periods t5 and t6, and, for Pixel B there is an upward arrow between time periods t0 and t1, a downward arrow between time periods t1 and t2, an upward arrow between time periods t4 and t5, and a downward arrow between time periods t5 and t6.

Accordingly, aspects of embodiments of the present disclosure relate to systems and methods for increasing the efficiency of performing structured light 3-D reconstruction using an event camera instead of a standard digital camera. In particular, the ability of an event camera to output data only upon detecting changes in the intensity of light (e.g., corresponding to the upward and downward arrows in FIG. 3B) makes it well-suited to detecting the changes in intensity caused by projecting different patterns 310 onto a scene. Some advantages of event cameras include extremely high dynamic range due to generating events only on detections of changes in brightness and asynchronous high speed data capture at very low temporal resolution (reaching microseconds, as noted above). In particular, the intensity change measurements at the pixels simplifies the matching process between camera pixels and projected pixels, and the high speed data capture allows the capture of precise binary coding level structured light, thereby enabling 3-D reconstruction in real-time or near real-time. In addition, the high speed of the data capture makes event cameras well suited to 3-D reconstruction in environments with moving objects (e.g., robotic assembly), and the detection of changes in illumination intensity, rather than absolute intensity, increases the effective dynamic range of the event cameras, thereby making them useful in circumstances with variable or poor illumination. In many manufacturing environments, space constraints limit the degree to which additional illumination can be provided and throughput demands encourage the removal of bottlenecks due to, for example, the speed at which manufacturing robots can analyze their environments. As such, these properties make event cameras well suited to capturing information for 3-D reconstruction using structured light in manufacturing and logistics environments with applications such as robotic automation in bin picking, 3-D scanning for defect analysis, object segmentation, and the like.

Referring back to FIG. 1, the projection system 10 and the event camera 20 are arranged such that the event camera 20 is arranged to detect light projected onto the scene 2 by the projection system 10 after reflecting off surfaces of the scene 2. In more detail, the projection system 10 and the event camera 20 are calibrated with respect to one another, such as by using the projection system 10 to project calibration patterns onto a scene and detecting the calibration patterns using the event camera 20. Examples of such techniques are described in Muglikar, Manasi, et al. “How to Calibrate Your Event Camera.” Proceedings of the IEEE/CVF Conference on Computer Vision and Pattern Recognition. 2021.

In various embodiments of the present disclosure, the projection system 10 may be implemented using, for example, a Digital Light Processing (DLP) projector using digital micromirror, a Liquid Crystal Display (LCD) projector, a Light Emitting Diode projector, a Liquid Crystal on Silicon (LCOS) projector, a laser projector, or the like.

In some embodiments of the present disclosure, the set of patterns 310 projected by the projection system 10 is selected to reduce or minimize the number of transitions between different patterns, thereby reducing the number of events detected by the event camera, without affecting the coverage of projecting patterns onto the scene or the ability to distinguish different portions of the projected pattern based on the detected codes. For example, in some embodiments the patterns are ordered such that they form a Gray code or reflected binary code where successive values differ in only one bit (e.g., one portion). For additional examples of binary codes, see Gupta, Mohit, et al. “Structured light 3D scanning in the presence of global illumination.” CVPR 2011. IEEE, 2011. In some embodiments a combination of a Gray code and phase shift are used to generate the pattern as described in, for example, Sansoni, Giovanna, Matteo Carocci, and Roberto Rodella. “Three-Dimensional Vision based on a Combination of Gray-Code and Phase-Shift Light Projection: Analysis and Compensation of the Systematic Errors.” Applied Optics 38.31 (1999): 6565-6573. In some embodiments, the patterns form a de Bruijn sequence.

FIG. 3C is a schematic depiction of light incident on a three subject pixels of the camera over the course a time period in which several patterns ordered in a Gray code are projected on a scene imaged by the camera. FIG. 3C is substantially similar to FIG. 3B, with the exception that the patterns 310 are arranged such that they are ordered in a Gray code (and replaces pattern 313 of FIG. 3B with new pattern 316), where temporally adjacent patterns differ by only one bit (e.g., at only one location). As a result, only one arrow, whether upward or downward, appears between any two periods. This, accordingly, reduces the number of portions of the scene that change in level of detected brightness between any two time periods. For example, FIG. 3B includes eight arrows indicating transitions between different brightness levels, whereas FIG. 3C shows six arrows. When the scene 2 is being imaged by an event camera, using Gray codes or other arrangements or ordering of patterns that reduce the number of transitions also reduces the number of events that will be detected by the camera at any given time. This can reduce the burden on the event camera, thereby enabling the projection of higher-resolution patterns, using higher resolution cameras, and/or projecting patterns more quickly (e.g., project the patterns for shorter time periods) while remaining within the readout rate of the event camera 20 or without saturating the output of the event camera 20.

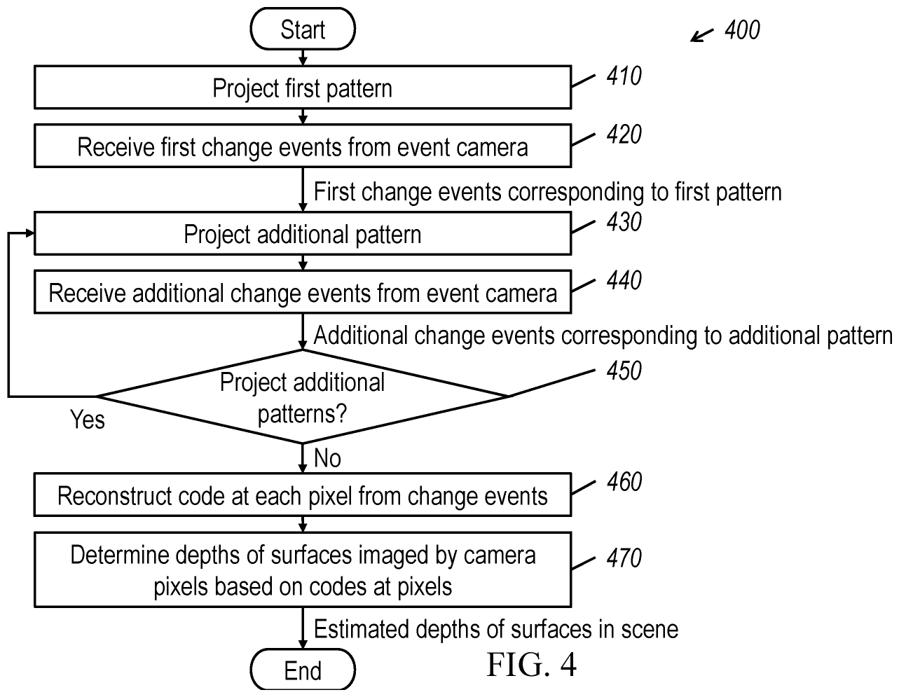

FIG. 4 is a flowchart of a method 400 for computing the depth of pixels based on events detected by an event camera in a system according to some embodiments of the present disclosure. In some embodiments of the present disclosure, the method is performed by a controller 30 or other host system. In various embodiments of the present disclosure, the controller 30 includes a processor and a memory, where the memory stores instructions that, when executed by the processor, cause the processor to perform operations associated with methods according to various embodiments of the present disclosure, including the operations of the method illustrated in FIG. 4. While one example embodiment of the present disclosure uses a processor, such as a general purpose microprocessor or microcontroller and memory, embodiments of the present disclose are not limited thereto. For example, some or all operations may be performed by other types of processors (e.g., a graphical processing unit or GPU, a neural accelerator processor, a field programmable gate array or FPGA, and/or an application specific integrated circuit or ASIC). In addition, the method may be divided among multiple, physically separate computing systems that make up different portions of the controller, such as a first computing system configured to control the projection system 10, a second computing system configured to control and/or receive data from the event camera 20 and to compute reconstructions of the depths of surfaces based on data received from the event camera 20. In some embodiments, the operations of receiving event data from the event camera 20 and the reconstruction of the depths of surfaces are performed by physically separate computing devices. The multiple, physically separate computing devices of controllers according to some embodiments of the present disclosure may be connected to one another and/or communicate with one another based on, for example, a direct peripheral bus connection (e.g., a Universal Serial Bus connection), a local area network connection (e.g., wired or wireless Ethernet), or a wide area network connection (e.g., over the Internet).

Referring to FIG. 4, in operation 410 the controller 30 controls the projection system 10 to project a first pattern onto the scene 2. In operation 420, the controller 30 receives first events corresponding to the projection of the first pattern onto the scene 2.

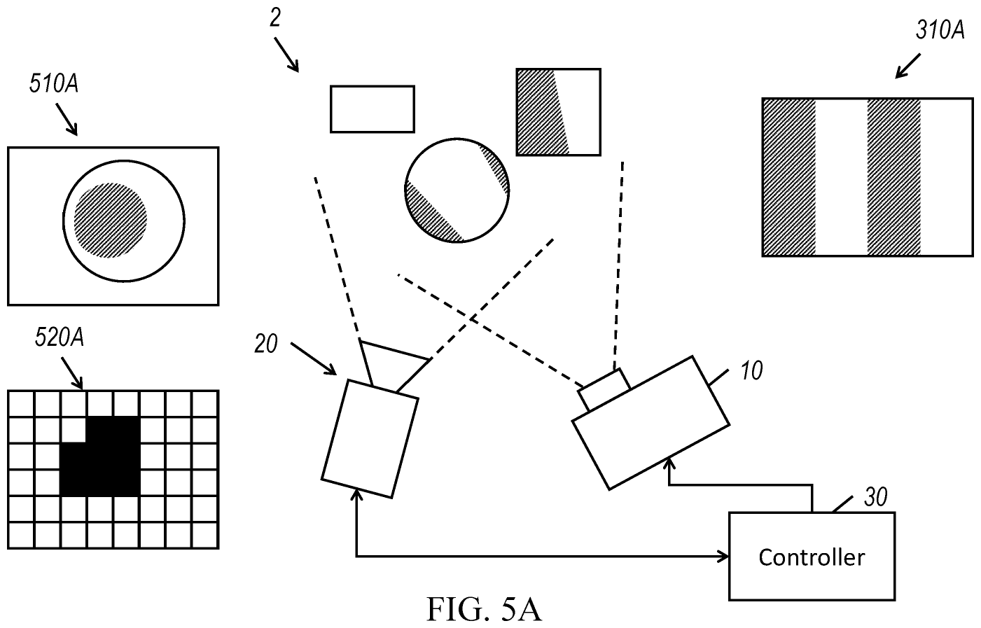

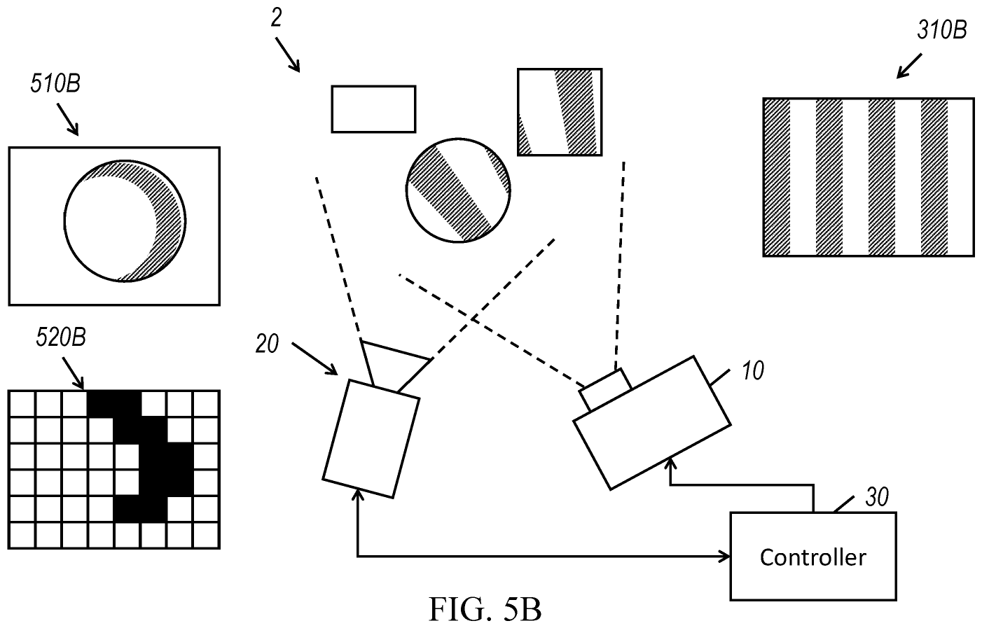

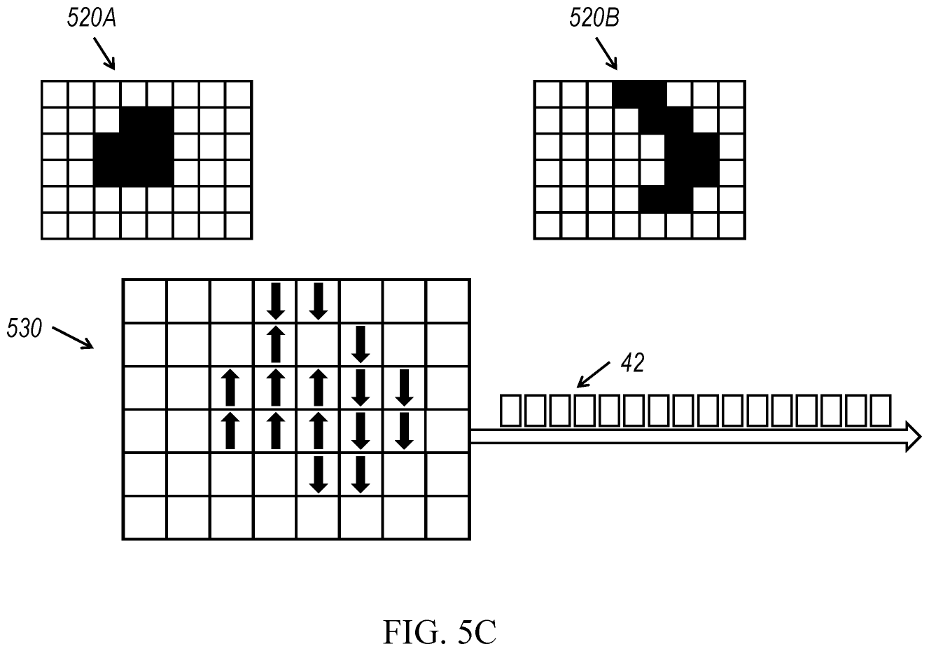

FIG. 5A is a schematic depiction of the scene brightness detected at a portion of an image sensor of an event camera due to a first projected pattern during a first time period according to one embodiment of the present disclosure. In the example shown in FIG. 5A, during the first time period (e.g., t1), the controller 30 controls the projection system 10 to emit a first pattern 310A onto the scene 2. The particular example pattern 310A shown in FIG. 5A has an alternating pattern of four stripes, where the first and third stripes have no projected light (e.g., “0”), and the second and fourth stripes have projected light (e.g., “1”). Light reflecting off a sphere in the scene 2 and toward the event camera 20 may generally form an image 510A on the image sensor, where the portions of the sphere that are not illuminated by the additional projected light are shown with shading (e.g., where the illuminated area has a white, crescent shape surrounding a shaded, rounded area). An 8×6 grid of sensor pixels of the image sensor 22 that receive light from the portion of the scene 2 corresponding to the sphere is schematically depicted at 520A, where the white pixels indicate locations where illumination was provided by the projection system 10 and dark pixels indicate locations that were not illuminated by the projection system. Assuming that the projection system 10 was not emitting light prior to this first time period, the event camera 20 generates change events corresponding to the locations where additional illumination (increased brightness) is now detected (e.g., all of the white pixels in the grid 520A). As noted above, each of the change events may include a timestamp, a row and column of the change event, and a direction of the change event (e.g., increase or decrease in detected brightness).

In operation 430, the controller 30 projects an additional pattern onto the scene 2, where the additional pattern is different from any previously projected patterns (e.g., the first pattern). In operation 440, the controller 30 receives additional change events from the event camera 20 corresponding to the additional projected pattern. In some embodiments, the next pattern is projected immediately after the previous pattern, that is, without a gap period in which no light is projected onto the scene 2, because such a gap, if sufficiently long, would cause the event camera 20 to detect additional change events corresponding to the decrease in illumination back to baseline levels (no illumination, thereby resulting in a decrease in detected brightness).

FIG. 5B is a schematic depiction of the scene brightness detected at the portion of the image sensor of the event camera due to a second projected pattern during a second time period (e.g., t2) according to one embodiment of the present disclosure. The particular example pattern 310B shown in FIG. 5B has an alternating pattern of eight stripes, where the first, third, fifth, and seventh stripes have no projected light (e.g., “0”), and the second, fourth, sixth, and eighth stripes have projected light (e.g., “1”). As seen in FIG. 5B, the different pattern 310B causes different portions of the scene 2 to be illuminated or not illuminated. This different illumination pattern is illustrated by the image 510B formed on the image sensor, where the sphere now shows a large, white illuminated area and a crescent-shaped dark area. The levels of brightness received at the 8×6 grid of sensor pixels now has a different arrangement as depicted at 520B.

FIG. 5C is a schematic depiction of the change events output by an event camera due to the change in the brightness detected due to the first projected pattern during the first time period and the second projected pattern during the second time period. In more detail, FIG. 5C shows the light levels received by the pixels during the first time period (e.g., t1) as grid 520A and the light levels received by the pixels during the second time period (e.g., t2) as grid 520B. Because the event camera produces output events at the changes in detected brightness levels, pixels that detected changes in illumination generate events, as illustrated at 530, where pixels that changed from dark to bright output a positive change in illumination (upward arrow), and pixels that changed from bright to dark output a negative change in illumination (downward arrow). Pixels that detected no change (e.g., stayed bright or stayed dark) produce no output (e.g., blank spaces in the grid of change events 530).

Accordingly, the event camera 20 generates additional camera-level change events 42 corresponding to the additional pattern projected onto the scene, and the controller 30 receives these additional change events from the event camera 20.

In operation 450, the controller 30 determines whether additional patterns are to be projected. For example, in some embodiments, there is a stored and/or otherwise specified sequence of patterns to be projected onto a scene to perform structured light reconstruction. If there are additional such patterns to project, then the controller 30 controls the projection system to project the next pattern at operation 430, and the process loops until all of the different patterns of the sequence have been projected.

When there are no additional patterns to project, then at operation 460 the controller 30 reconstructs the code at each pixel is reconstructed based on the camera-level change events 42 received from the event camera 20. For example, referring back to FIG. 3B and FIG. 3C, each pixel may be assumed to start at 0. A positive change event corresponds to a change at that pixel to a value of 1 due to and/or corresponding to the pattern projected during a particular time period. A negative change event during a particular time period corresponds to a change to a value of 0. No change event for a particular time period corresponds to the pixel having the same brightness level as the previous time period (e.g., a 0 or a 1). Camera-level change events 42 are correlated with the corresponding projected patterns that caused the events based on the timestamps of the camera-level change events. Accordingly, the controller 30 reconstructs the projected structured light codes that were detected at the pixels of the event camera 20 based on the camera-level change events 42 received from the event camera 20.

While the projection system 10 is described above in embodiments where the controller 30 actively controls the timing of the patterns emitted by the projection system 10, embodiments of the present disclosure are not limited thereto. In some embodiments, the projection system 10 operates semi-autonomously and projects different patterns onto a scene during different time periods, as controlled by a timer and set of stored patterns or other control of patterns (e.g., a digital counter) internal to the projection system 10.

In operation 470, the controller 30 determines the depths of surfaces in the scene 2 as imaged by the event camera 20 based on the reconstructed codes at the locations of the pixels, by applying the techniques for structured light 3-D reconstruction, such as those described above in Zhang, Song. “High-speed 3D shape measurement with structured light methods: A review.” Optics and Lasers in Engineering 106 (2018): 119-131 and in Geng, Jason. “Structured-light 3D surface imaging: a tutorial.” Advances in Optics and Photonics 3.2 (2011): 128-160.

In some embodiments, the resolution of the projection system 10 is less than or equal to the resolution of the event camera 20. Generally speaking, when the resolution of the patterns projected by the projection system 10 is higher than the spatial resolution of the image sensor of the event camera 20, the event camera 20 may be unable to resolve the patterns projected, thereby making the reconstruction of the codes difficult or reducing the effective resolution of the projected pattern.

Therefore, aspects of embodiments of the present disclosure relate to systems and methods for 3-D reconstruction using projected structured light as detected by an event camera. Using an event camera increases the speed at which the projected patterns are detected and enables the high-speed, low latency detection of projected patterns over a large dynamic range of possible operating conditions without little to no motion blur because the event cameras generate output quickly and asynchronously upon detecting changes in the illumination level, which is compatible with the high speed projection of patterns onto a scene (e.g., in the case of some DLP projectors, 1440 Hz or higher, depending on the characteristics of the patterns being projected, where such projectors are generally capable of higher output frame rates for binary patterns or black/white patterns).

While some embodiments of the present disclosure are presented above in the context of a single event camera working in conjunction with a single projection system, embodiments of the present disclosure are not limited thereto. In various other embodiments of the present disclosure, multiple event cameras (e.g., at different viewpoints) and/or a projection system with multiple projectors (e.g., projecting light from different poses with respect to the scene) can be used to implement active stereo as an alternative to structured light.

Generally, in a stereo depth reconstruction system, multiple cameras are arranged with overlapping fields of view and with generally parallel optical axes (e.g., arranged side-by-side). Active stereo refers to the case where a projection source projects patterned light onto the scene. The projected pattern reflects off the scene and is imaged by the cameras, and parallax effects may cause corresponding (or “matching”) portions (or “blocks”) of the pattern to appear at different locations on the image sensors of the cameras. The difference in locations of the portion of the pattern may be referred to as “disparity.” In particular, due to parallax effects, detected matching patterns that have lower disparity indicate surfaces that are farther away from the stereo pair of cameras (e.g., at greater depth) whereas greater disparity indicates that the surfaces are closer to the stereo pair of cameras (e.g., at lesser depth).

Some aspects of embodiments of the present disclosure relate to using event cameras in active stereo depth reconstruction systems. For example, in some embodiments of the present disclosure, multiple event cameras are used together with a single projection system. The multiple event cameras may be arranged as one or more stereo pairs, where a stereo pair of event cameras are calibrated with respect to one another and have substantially parallel optical axes with overlapping fields of view to image a scene from different viewpoints. The single projection system may be configured to project a light pattern (e.g., a dot pattern) onto the scene imaged by the multiple event cameras. The light pattern may be designed such that each local portion of the light pattern is unique across the entire light pattern projected over the field of projection. When the projection system is turned on (e.g., begins emitting light), the event cameras generate events at event pixels that image portions of the scene that are illuminated by the light pattern. As such, the events are expected to have the same general spatial pattern as the projected light pattern, as distorted or shifted based on the depth of the surfaces of the scene that reflect the projected light. The uniqueness of the local portions of the pattern make it possible to find matching portions of the dot pattern as detected by the different event cameras of the stereo pair. Accordingly, the depth of an imaged surface can be determined based on, for example, a disparity calculation (e.g., detecting the difference in position of the detected local portion of the light pattern along an epipolar line between the event cameras) to generate a disparity map or by using a trained neural network configured to compute disparity and/or depths of pixels (e.g., a trained convolutional neural network, see, e.g., Chang, Jia-Ren, and Yong-Sheng Chen. “Pyramid stereo matching network.” Proceedings of the IEEE Conference on Computer Vision and Pattern Recognition. 2018 and Wang, Qiang, et al. “Fadnet: A fast and accurate network for disparity estimation.” 2020 IEEE International Conference on Robotics and Automation (ICRA). IEEE, 2020).

Multiple projection systems may also be used to project light patterns onto the scene, either concurrently or in sequence (e.g., time multiplexed). For example, some surfaces that are visible to the event cameras may be occluded with respect to one or more of the projectors. Therefore, additional projectors may illuminate and provide patterns to those surfaces, thereby enabling the computation of the depths of those surfaces.

For reasons similar to those described above in the case of projecting a sequence of coded light patterns onto a scene, using active stereo (e.g., using a single pattern or a fixed pattern) with event cameras provides benefits in the form of improved dynamic range, low latency, and reduced artifacts due to motion blur. For example, the event cameras generate events in response to the detection of changes in detected brightness, which are assumed to be caused entirely by the start of the projection of the light pattern onto the scene by the light projector. As such, the camera-level change events, as synchronized with the time period during which the light is projected. Assuming the time period of light projection (or projection interval) is short relative to the speed of movement of objects in the scene, then little to no motion blur will be detected by the event cameras (e.g., substantially no motion blur when objects of interest move by no more than one pixel during the time period of projection). In addition, because events are generated only by pixels that detect changes in brightness, assuming that the projected light pattern is sparse, only small number of all of event pixels will generate events during the projection interval, thereby reducing the data bandwidth requirements for transmitting the captured image data.

Therefore, aspects of embodiments of the present disclosure relate to systems and methods for performing 3-D reconstruction using event cameras, thereby enabling high speed, low latency, and high quality generation of depth maps (e.g., 3-D models and/or point clouds) of scenes. The computed depth maps may be further processed by a computing system, such as to perform object classification, pose estimation, defect detection, or the like, where the results of the further processing may be used to control robotic systems, such as sorting objects based on classification or based on the presence of defects and/or picking objects with a robotic gripper based on the estimated pose of the object.

Segmentation Using Event Cameras

Accurate object segmentation is an important problem in robotic applications, such as for performing computations on single, segmented objects within the captured images. These object-level computations may include, for example, classification (e.g., determining what type of object is imaged), pose estimation (e.g., determining the position and orientation of the object), defect detection (e.g., detecting surface defects in the object), and the like. The process of object segmentation can be complicated and less accurate for a moving object (e.g., an object on a conveyor belt), especially if motion blur is present (e.g., when the exposure interval is long relative to the speed of movement of the object, such as when the object moves more than 1 pixel in the view of the camera during the exposure interval). Some embodiments of the present disclosure relate to performing object segmentation of moving objects using event cameras, which provide high temporal resolution, combined with the deep learning based object segmentation techniques.

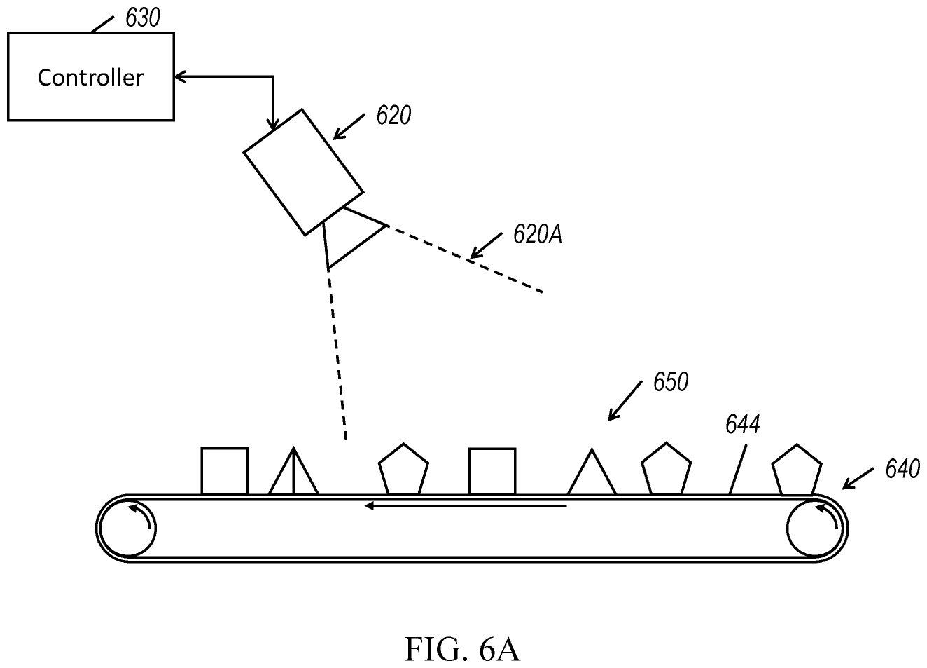

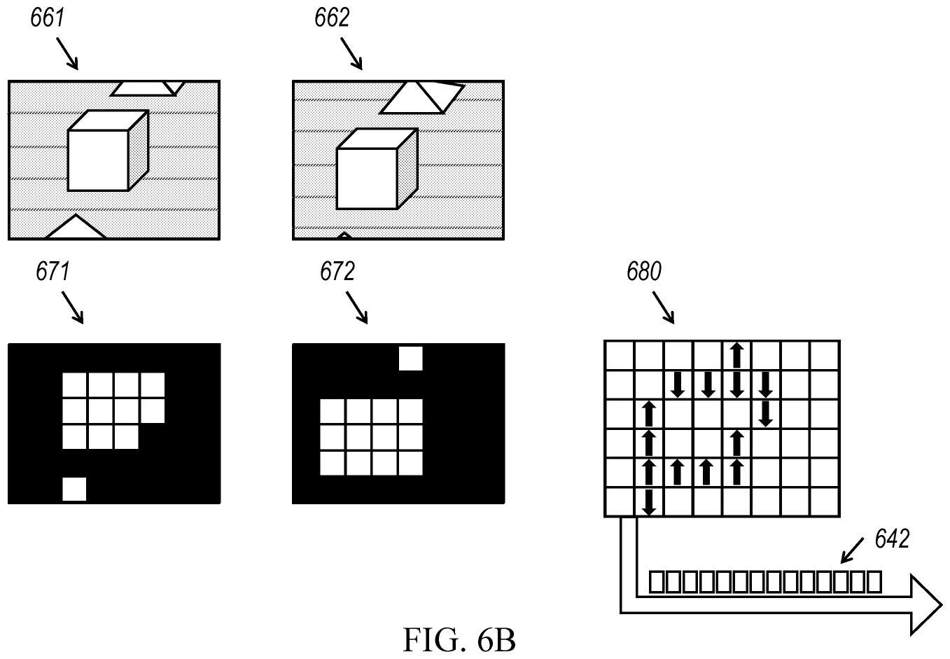

FIG. 6 is a schematic depiction of a computer vision system including an event camera imaging a conveyor belt with a plurality of different objects, where the computer vision system is configured to segment the objects from the scene, such as by compute segmentation masks, based on events generated by the event camera, according to one embodiment of the present disclosure.

In the arrangement shown in FIG. 6A, an event camera 620, in communication with a controller 630, is directed at a conveyor belt 640 with multiple objects 650 resting on the top surface 644 of the conveyor belt, where the conveyor belt 640 moves or conveys the objects 650 along a direction of motion, as indicated by the arrow in FIG. 6, where the objects 650 are moved into, and then out of, the field of view 620A of the event camera 620. In the arrangement shown in FIG. 6, it is assumed that substantially constant illumination (or steady illumination) is provided to the scene imaged by the event camera (e.g., the objects 650 and the top surface 644 of the conveyor belt 640), in contrast to systems in which a projection system projects different patterns on the scene at different times. In some embodiments, the substantially constant illumination is provided by a projection system similar to the projection systems described above (e.g., projection system 10). In some embodiments, the substantially constant illumination is provided by ambient lighting conditions, with the projection system 610 projecting substantially no light onto the scene (e.g., turned off).

FIG. 6B is a schematic depiction of events generated by an event camera imaging objects moving along a conveyor belt according to one embodiment of the present disclosure. In the illustrated arrangement, it is assumed that the objects are bright relative to the top surface of the conveyor belt, which is dark, but embodiments of the present disclosure are not limited thereto and may operate so long as there is sufficient contrast between the appearance of the top surface of the conveyor belt and the objects (e.g., the objects may be brighter or darker than the conveyor belt and/or differently colored than the conveyor belt). In addition, it is assumed in this description that the top surface of the conveyor belt is monotone, however, embodiments of the present disclosure are not limited thereto and, with calibration, the approach described herein can be applied to conveyor belts that are not monotone. For example, a conveyor belt having a fixed, known pattern on its surface can be automatically detected and removed (e.g. subtracted) from the event camera image to leave the events associated with the objects on the conveyor belt. Similarly, embodiment of the present disclosure are not limited to use with segmenting objects on conveyor belts. For example, objects conveyed by an overhead conveyor system can be segmented from static backgrounds using similar techniques because the static backgrounds do not cause the event camera to generate events. Accordingly, some embodiments of the present disclosure relate to segmenting objects from static backgrounds based on the locations of detected events corresponding to the edges of moving objects.

In more detail, image 661 depicts a view of some objects on the conveyor belt from the viewpoint of the event camera at a first time, and image 662 depicts a view of the same objects on the conveyor belt from the same viewpoint at a second time, after the conveyor melt has moved the objects. Grids 671 and 672 generally depict the intensity of light received at the event camera, where it is assumed that the top surface of the conveyor belt is dark and the objects are bright. Grid 680 depicts the camera-level events 642 generated by the event camera due to the changes in detected brightness between the first time period and the second time period. In particular, some pixels report increased brightness events, corresponding to a portion (e.g., an edge) of an object entering into the view of that pixel, and some pixels report decreased brightness events, corresponding to a portion of an object exiting the view of that pixel. Because it is assumed that the conveyor belt is mostly monotone in appearance, most of the events will be generated at the edges of the objects (and potentially in the regions corresponding to the surface of the objects, depending on the presence of high contrast features or patterns on the surfaces of the objects). As such, the locations of the events correspond to the edges or outline of the moving objects in the scene, and the silhouettes of the objects can be detected accordingly.

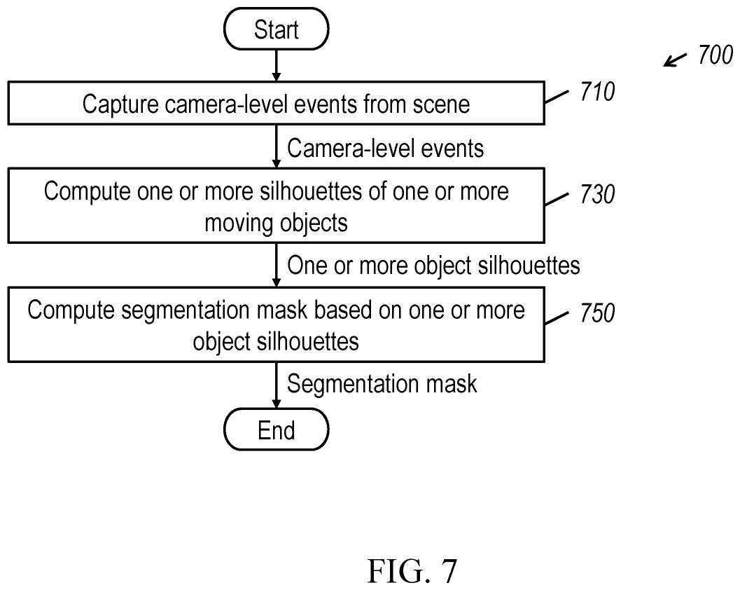

FIG. 7 is a flowchart of a method 700 for computing segmentation masks based on camera-level event data from an event camera according to one embodiment of the present disclosure. In operation 710, an event camera captures the intensity change at each pixel, e.g., as represented by the grid 680 is FIG. 6B. Under the assumption that the largest intensity changes occur at the edges of the objects 650 on conveyor belt 640, the contour and silhouette of the object is apparent at the locations of the change events in the camera-level events generated by the event camera. Accordingly, in operation 730, the controller 630 computes one or more silhouettes of the one or more objects based on the locations of the change events generated by the event camera 620 (e.g., where the locations of the change events identify locations of the edges of the objects). Depending on the relative color or brightness of the object relative to the background, the change events may correspond to brightness increases or brightness decreases at the leading edge of the direction of movement of the object and vice versa at the trailing edge of the direction of movement. In the example shown in FIG. 6B, the object is brighter than the background conveyor belt and is depicted as moving diagonally from the upper right toward the lower left (toward the event camera). Therefore, the leading edge of the moving object is located toward the bottom of the image and the trailing edge of the moving object is located toward the upper part of the image. Because the object is brighter than the background, the movement of the leading edge of the object into the view of pixels that previously imaged a darker background of the conveyor belt will detect brightness increase events (upward arrows), as shown by the upward arrows in the lower and left side of grid 680. Likewise, event pixels that previously imaged the trailing edge of the object will image the darker conveyor belt, therefore generating brightness decrease events (downward arrows), as shown by the downward arrows in the upper and right side of the image. (In the case of objects darker than the conveyor belt, direction of the events is reversed, where the leading edge of the object is detected by brightness decrease events and the trailing edge of the object is detected by brightness increase events.)

In some embodiments the controller 630 determines which pixels correspond to the inside of the object versus the outside of the object based on knowledge of the relative brightness of the objects and the background conveyor belt and the direction of motion of the objects. Continuing with the example shown in FIG. 6B, in some cases it may be assumed that the area between a trailing edge of the object and a leading edge of the object corresponds to the area of the object (e.g., by performing a flood-fill operation parallel to the direction of motion between the trailing edge and the leading edge of the object).

In operation 750, the object (or objects) is segmented based on the computed one or more silhouettes. Machine learning-based techniques (e.g., using a trained convolutional neural network) can be used for additional instance segmentation based on the low latency segmentation mask computed using the events from the event camera to compute an instance segmentation mask that labels each of the one or more objects in the image with corresponding object classifications determined by the instance segmentation operation (e.g., classified based on type of object). For example, the comparative machine learning techniques may be applied to images captured by a color camera located at substantially the same viewpoint as the event camera 620 or by the active pixel sensors 23A of the event camera 620.

Therefore, aspects of embodiments of the present disclosure relate to systems and methods for performing object segmentation using event cameras, thereby enabling high speed, low latency, and high quality segmentation of images to extract objects from those images. The extracted images are then supplied for further processing, such as for object classification, pose estimation, defect detection, or the like, where the results of the further processing may be used to control robotic systems (e.g., sorting objects based on classification or based on the presence of defects and/or picking objects with a robotic gripper based on the estimated pose of the object).

Combinations of semantic segmentation and 3-D reconstruction using event cameras

Some aspects of embodiments of the present disclosure relate to performing both semantic segmentation and 3-D reconstruction of a scene using the techniques described above. For example, in some embodiments, a segmentation mask is computed from a scene with the illumination is held constant (e.g., with the projection system 10 projecting no light or projecting a fixed pattern) and then a 3-D reconstruction of the scene is performed by projecting one or more patterns onto the scene (e.g., a sequence of patterns in the case of structured light reconstruction or one or more patterns in the case of active stereo), and a depth map is computed from the events generated by the event cameras during the projection of the one or more patterns. The segmentation mask may then be used to segment the depth map to isolate individual objects (e.g., to extract individual point clouds or 3-D models corresponding to individual objects).

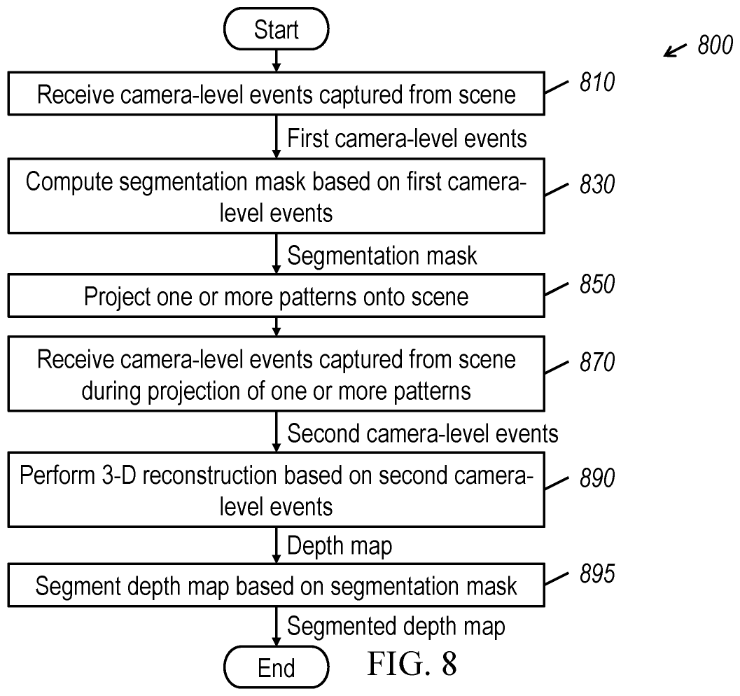

FIG. 8 is a flowchart of a method 800 for computing a segmented depth map according to one embodiment of the present disclosure. In operation 810, a controller (e.g., controller 630) receives first camera-level events captured by an event camera (e.g., event camera 620) where the illumination of the scene is maintained substantially constant. In operation 830 the controller computes a segmentation mask based on the first camera-level events, such as by using techniques in accordance with the embodiments described above with respect to FIGS. 6A, 6B, and 7. In operation 850, one or more patterns are projected onto the scene and second camera-level events are captured from the scene (e.g., in response to the changes in detected brightness due to the projection of the patterns) in operation 870. The controller performs 3-D reconstruction of the scene based on these second camera-level events, such as by using techniques in accordance with the embodiments described above with respect to FIGS. 4, 5A, 5B, and 5C, to compute a depth map in operation 890. In operation 895, the segmentation mask computed in operation 830 is then used to segment the depth map to generate a segmented depth map, which may include one or more separate 3-D models (e.g., point clouds or mesh models) corresponding to the different objects that were segmented in operation 830. As such, the same event camera system may be used to perform both scene segmentation and 3-D reconstruction (or depth reconstruction), which may be used to segment the resulting depth map. The segmented 3-D models may then be used for further analysis (e.g., pose estimation, object classification, defect detection, and the like) as discussed above, where the results of the further analysis may be used to control a robotic system to manipulate the objects in the scene captured by the computer vision system.

As discussed above, aspects of embodiments of the present disclosure are directed to various systems and methods for performing computer vision tasks, including segmentation and 3-D reconstruction (using, for example, structured light or active stereo) based on brightness change events captured by event cameras. The use of event cameras enables higher speed and lower latency capture of images than standard cameras, thereby reducing artifacts due to motion blur when imaging moving objects and enabling the use of such computer vision systems in high dynamic range situations or other lighting conditions that would be challenging for comparative, standard camera modules.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An active scanning system comprising:
an event camera comprising a plurality of event pixels configured to generate change events based on detecting changes in detected brightness;
a projection system;
a controller configured to receive camera-level change events from the event camera, the controller comprising a processor and memory, the memory storing instructions that, when executed by the processor, cause the controller to:
receive first change events from the event camera corresponding to a first pattern projected by the projection system into a scene in a field of view of the event camera; and
compute a plurality of depths of surfaces imaged by the event camera at the event pixels associated with the first change events to generate a depth map.

2. The active scanning system of claim 1, wherein the memory further stores instructions that, when executed by the processor, cause the controller to:
receive additional change events from the event camera corresponding to additional patterns projected by the projection system into the field of view of the event camera;
reconstruct a plurality of illumination codes based on the first change events and the additional change events detected by the event camera, each of the plurality of illumination codes being associated with a corresponding one of the event pixels of the event camera; and
compute the plurality of depths of surfaces imaged by the event camera at the event pixels associated with the plurality of illumination codes based on the illumination codes and a plurality of calibration parameters between the projection system and the event camera.

3. The active scanning system of claim 2, wherein the additional patterns comprise two or more patterns.

4. The active system of claim 2, wherein the memory further stores instructions that, when executed by the processor, cause the controller to control the projection system to project the first pattern during a first time period.

5. The active system of claim 4, wherein the memory further stores instructions that, when executed by the processor, cause the controller to control the projection system to project the additional patterns during a plurality of additional time periods.

6. The active scanning system of claim 1, further comprising a second event camera forming a stereo pair with the event camera,
wherein the memory further stores instructions that, when executed by the processor, cause the controller to:
receive second change events from the second event camera corresponding to the first pattern projected by the projection system into the field of view of the second event camera.

7. The active scanning system of claim 6, wherein the memory further stores instructions that, when executed by the processor, cause the controller to compute the plurality of depths of surfaces imaged by the event camera to generate the depth map by:
computing a disparity map by matching blocks of events among the first change events and the second change events corresponding to same portions of the first pattern projected by the projection system.

8. The active scanning system of claim 1, wherein the memory further stores instructions that, when executed by the processor, cause the controller to:
receive third change events from the event camera during a period in which the field of view of the event camera is under substantially constant illumination;
compute one or more silhouettes of one or more moving objects based on the third change events;
compute a segmentation mask based on the one or more silhouettes; and
segment the depth map based on the segmentation mask to compute a segmented depth map.

9. A scanning system comprising:
an event camera comprising a plurality of event pixels configured to generate change events based on detecting changes in detected brightness;
a controller configured to receive camera-level change events from the event camera, the controller comprising a processor and memory, the memory storing instructions that, when executed by the processor, cause the controller to:
receive first change events from the event camera during a period in which a scene in a field of view of the event camera is under substantially constant illumination;
compute one or more silhouettes of one or more moving objects based on the first change events; and
compute a segmentation mask corresponding to the one or more moving objects based on the one or more silhouettes.

10. The scanning system of claim 9, wherein the memory further stores instructions that, when executed by the processor, cause the processor to perform instance segmentation on the segmentation mask to compute an instance segmentation mask labeling images of the one or more moving objects based on one or more object classifications.

11. A method for performing three-dimensional reconstruction of scenes, the method comprising:
projecting, by a projection system, a first pattern onto a scene;
receiving, by a controller comprising a processor and memory, first change events from an event camera, the first change events corresponding to the first pattern projected by the projection system into a scene in a field of view of the event camera, the event camera comprising a plurality of event pixels configured to generate change events based on detecting changes in detected brightness; and
computing, by the controller, a plurality of depths of surfaces imaged by the event camera at the event pixels associated with the first change events to generate a depth map.

12. The method of claim 11, further comprising:
projecting, by the projection system, additional patterns onto the scene in the field of view of the event camera;
receiving, by the controller, additional change events from the event camera corresponding to the additional patterns projected by the projection system;
reconstructing, by the controller, a plurality of illumination codes based on the first change events and the additional change events detected by the event camera, each of the plurality of illumination codes being associated with a corresponding one of the event pixels of the event camera; and
computing, by the controller, the plurality of depths of surfaces imaged by the event camera at the event pixels associated with the plurality of illumination codes based on the illumination codes and a plurality of calibration parameters between the projection system and the event camera.

13. The method of claim 12, wherein the additional patterns comprise two or more patterns.

14. The method of claim 12, further comprising controlling the projection system to project the first pattern during a first time period.

15. The method of claim 14, further comprising controlling the projection system to project the additional patterns during a plurality of additional time periods.

16. The method of claim 11, further comprising receiving second change events from a second event camera forming a stereo pair with the event camera, the second change events corresponding to the first pattern projected by the projection system into the field of view of the second event camera.

17. The method of claim 16, further comprising computing the plurality of depths of surfaces imaged by the event camera to generate the depth map by:
computing a disparity map by matching blocks of events among the first change events and the second change events corresponding to same portions of the first pattern projected by the projection system.

18. The method of claim 11, further comprising:
receiving third change events from the event camera during a period in which the field of view of the event camera is under substantially constant illumination;
computing one or more silhouettes of one or more moving objects based on the third change events;
computing a segmentation mask based on the one or more silhouettes; and
segmenting the depth map based on the segmentation mask to compute a segmented depth map.

19. A method for segmenting an image of a scene, the method comprising:
receiving, by a controller comprising a processor and memory, first change events from an event camera during a period in which a scene in a field of view of the event camera is under substantially constant illumination, the event camera comprising a plurality of event pixels configured to generate change events based on detecting changes in detected brightness;
computing, by the controller, one or more silhouettes of one or more moving objects based on the first change events; and
computing, by the controller, a segmentation mask corresponding to the one or more moving objects based on the one or more silhouettes.

20. The method of claim 19, further comprising performing instance segmentation on the segmentation mask to compute an instance segmentation mask labeling images of the one or more moving objects based on one or more object classifications.
